(19) United States
(12) Patent Application Publication
(10) Pub. No.: US 2004/0126183 A1
(43) Pub. Date: Jul. 1, 2004

(54) Assembly member for flat tools

(75) Inventor: Jean-Pierre Steiner, Crissier (CH)

Correspondence Address: OSTROLENK FABER GERB & SOFFEN, 1180 AVENUE OF THE AMERICAS, NEW YORK, NY, 100368403

(73) Assignee: Bobst SA

(21) Appl. No.: 10/737,265

(22) Filed: Dec. 15, 2003

(30) Foreign Application Priority Data
Dec. 18, 2002 (CH) 2002 2158/02

(51) Int. Cl. F16D 1/00

(52) U.S. Cl. 403/348

(57) ABSTRACT

Assembly member for parallel flat tools. Untapped openings pass through the tools. The assembly member includes a cylindrical unit with a rotation axis, against which unit are arranged at least two wings enabling to solidify and to tighten the flat tools through the openings by means of rotation of less than 360° of the assembly member around its rotation axis, without adding any substance nor adhesive element or another mechanical fastening piece.

### BACKGROUND OF THE INVENTION

The present invention relates to an assembly member for parallel flat tools, which are generally used in pairs in packaging production machines, like platen presses for example.

Package production machines generally include a succession of several working stations through which sheets of paper, cardboard or plastic matter travel, one by one, in order to produce box-blanks. Usually, each sheet is taken from the top of a pile and is then conveyed into a die cutting station where each box-blank is die cut between a fixed upper beam and a movable lower platen on which the sheet lays. The sheet is then conveyed into a stripping station where waste areas are ejected from the sheet by pinching the waste regions between a plurality of strippers. Once it has been die cut and its waste has been stripped, the sheet is finally conveyed into a delivery station to fall on top of an output pile.

To carry out the die cutting and waste stripping operations, the respective working stations are equipped with flat tools, generally comprising a rectangular wooden base plate, in which there are inserted knives, respectively strippers. The stripping station usually includes at least two flat tools, including a lower tool with apertures for stripping the wastes of the sheet downward and an upper tool equipped with stripping pins for pushing these waste regions though the apertures of the lower tool.

The upper tool and the lower tool thus form a pair of flat tools that work together for a series of sheets corresponding to a specific job. That means that it will be necessary to deal with as many pairs of flat tools as the number of different jobs require. The storage of these flat tools is thus rational, to enable them to be used later at the time of returning to a same job.

The present invention has an aim of making the handling and the storage preparation of the flat tools easier. To preserve the useful life of the upper flat tool, which remains delicate because of the projections issued from the stripping pins, the upper tool is made interdependent with the lower flat tool so that all stripping pins, like a sandwich, are protected between the two boards of the two flat tools. The assembly thus obtained forms a rigid unit that can easily be stored for later use.

For this assembly, it is known to use a set of screws, nuts and fitting crossbars which are usually intended to be arranged at the corners of the flat tools. To this end, each pair of flat tools includes, for example, four circular drillings and a fastening screw to be inserted through each drilling. The screw passes through a crossbar, which is comprised of a piece like a tube of any kind of material. The crossbar is beforehand inserted between the two flat tools, and is in touch with the tools. The length of the crossbar is such that it enables the flat tools to be spaced apart with a value slightly higher than the length of a stripping pin. To be able to bolt the whole together, a nut is finally tightened at the threaded end of the screw, and presses against the external face of one of the flat tools.

A replacement or alternative for the nut is a washer bored with a threaded hole. The washer is then fastened beforehand against one or the other face of the flat tool, and concentrically to the drilling of the tool. From a mechanical point of view, the aim is to substitute a simple threading, which may be impossible to be permanently carried out, into wooden boards, such as boards usually used for flat tools.

For each bolting, it is necessary to use at least three elements, namely a screw, a crossbar and a nut or a washer bored with a threaded hold. To deal with the assembly of the flat tools, it is thus necessary to fasten the washer beforehand with small flat screws, or preferably to use a nut, to arrange the crossbar between the flat tools, to insert the fastening screw and to tighten the whole unit by means of one or two appropriate tools.

The drawbacks of such an assembly is mainly the time needed for the handling, its relative high cost compared to the set aim, and the inevitable storage control of the three main elements required. In order to reduce the cost of such an assembly, some of these elements, such as the nut, the fastening screw or the washer, are obtained by molding of plastic rather than by machining starting from metallic elements. However, the release from molding is always a more complicated operation for a screw or a threaded part than for a cylinder that is not threaded. The result is a low limit, regarding the cost that is extremely difficult to reduce.

### SUMMARY OF THE INVENTION

The object of the present invention is to obviate the abovementioned drawbacks by considerably reducing the assembly time of flat tools, by minimizing the number of elements needed for the assembly and by lowering the total cost for such an operation. Advantageously, the number of the elements needed is reduced to unity, namely only one part per bolting. The subject matter of the present invention also advantageously allows itself to be handled and then tightened with only one hand, with or without need for a tightening key. Its fastening mode allows disassembly and a separation of flat tools as rapidly as their assembly. No material or adhesive part nor other additional mechanical piece is thus necessary for its use. Moreover, the subject matter of the invention is not consumed in a single use, and it also advantageously limits the storage of useful elements. Lastly, it can also be manufactured with a material that can be completely recycled while preserving useful minimal mechanical qualities ensuring a solid and reliable assembly.

To this end, the present invention has as an object of providing an assembly member.

Other features and advantages of the present invention will become apparent from the following description of the invention which refers to the accompanying drawings.

### BRIEF DESCRIPTION OF THE DRAWINGS

The invention will be better understood from an embodiment illustrated in the accompanying drawings in which:

FIG. 1 is a partial vertical cut view of part of a pair of flat tools assembled in an embodiment of the invention;

FIG. 2 is a plan view of the shape of the opening provided in the flat tools;

FIG. 3 is a three dimensional view according to a lower oblique view of the assembly member in a locked position within the flat tools;

FIG. 4 is also a three dimensional view of the assembly member itself, in an unlocked position, in contrast to FIG. 3.

### DESCRIPTION OF A PREFERRED EMBODIMENT

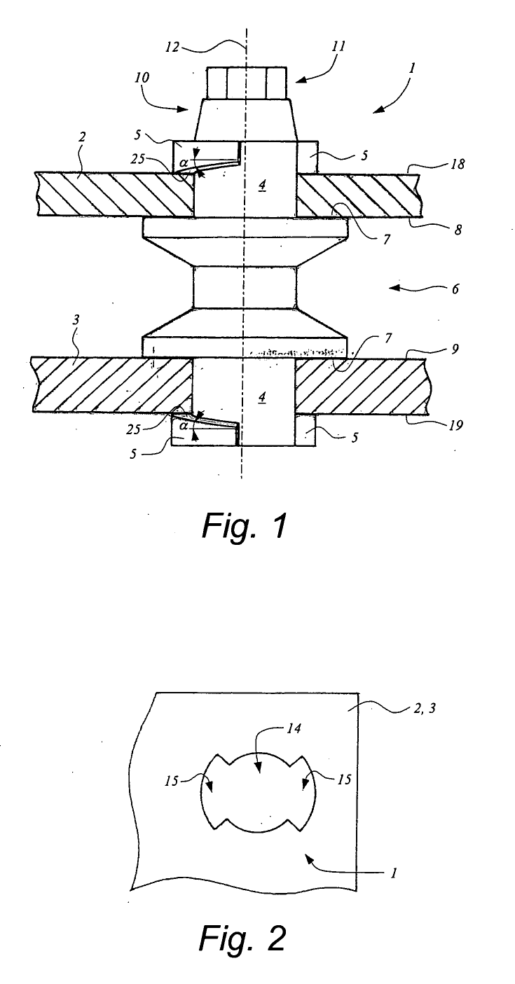

FIG. 1 shows a partial vertical cut view of an assembly member 1 for fastening an upper flat tool 2 to a lower flat tool 3, wherein the tools are parallel, forming a set that is easily dealt with like one main set. The member 1 includes a cylindrical member 4 that crosses right through the flat tools 2 and 3, and at each one end of the member there are fastening means. These fastening means preferably comprise a pair of wings 5 fastened against a portion of the circumference of the cylindrical body 4. Between the two flat tools 2 and 3, the cylindrical body preferably comprises a median part 6 which ends in two shoulders 7, which are advantageously planar and parallel and against which the interior respective sides 8, 9 of the higher flat tool 2 and lower flat tool 3 are supported. The cylindrical body 4 preferably terminates at least at one of its ends at a head 10 that is conically shaped. The head provides at least one exterior gripping profile 11 to the assembly member 1, even also an interior gripping profile to the member, making its seizure easier, either manually or by means of a tool such as a male wrench fork, for example, enabling the assembly member 1 to be turned easily around its rotation axis 12.

FIG. 2 shows the shape of the unthreaded openings 13 machined in the flat tools 2 and 3 which are related to one another in the same vertical plane. These openings can easily be machined using a laser, in only one operation, for example. The shape allows initial travel of the upper or lower elements of the assembly member 1 located on both axial sides of median part 6 and further enables the blocking and tightening of the assembly member 1 through flat tools 2, 3 by a simple rotation of the assembly member 1 of approximately a quarter turn. To this end, each opening 13 includes a central opening 14, cylindrically shaped, and two built-up openings 15. Preferentially, the two built-up openings 15 are shaped like crown portions which are symmetrically arranged around and against the circumference of the central opening 14.

While aligning the central opening 14 to the cylindrical body 4 and the built-up openings 15 to the wings 5, it is possible to insert the assembly member 1 into the openings 13 until the shoulders 7 of the median part 6 touch the interior sides 8 and 9 of the flat tools 2 and 3. Turning the assembly member 1 through an angle less than 360°, or less than the quota of this value by the number of wings 5, breaks the relationship between the built-up openings 15 and the wings 5 so that the assembly member is interdependent with the flat tools 2, 3 and they may not be separated. Moreover, in order to create a tightening effect of the assembly member against the flat tools, the wings 5 are shaped like a portion of a rectangular ring section and have a regularly variable height between one and the other end of the ring portion. This height variation gives each wing a helical guide 25 defining a plane slightly tilted by an angle α compared to a normal to the rotation axis 12. Each helical guide 25 is thus opposite to the nearest flat tool, more precisely to the related exterior face 18, 19. Revolution of the member 1 or the guide 25 around the rotation axis 12 gradually tightens this flat tool by constraining it to more firmly lean against the next shoulder 7.

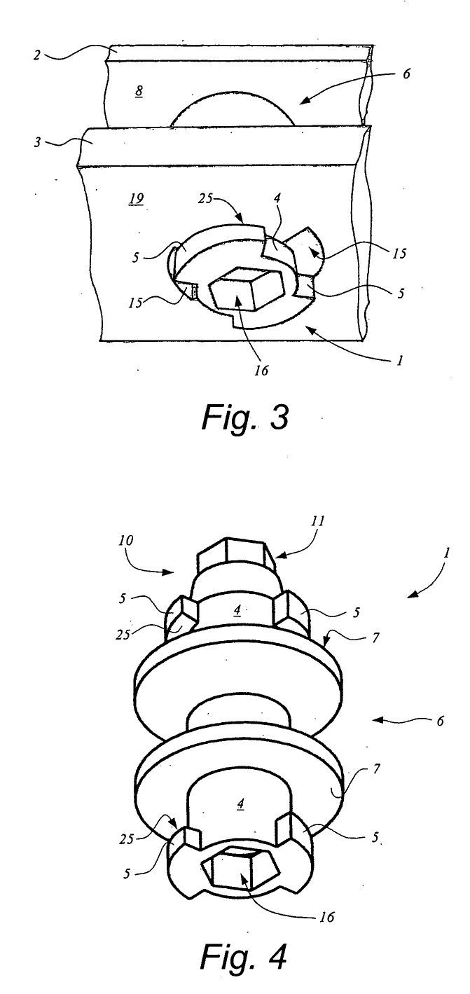

FIG. 3 shows a lower oblique view of the assembly illustrated in FIG. 1. This Figure represents the assembly member 1 in a locked position within the flat tools 2 and 3. In this Figure, the lower end of the cylindrical unit 4 is shaped to define an interior gripping profile 16 which would allow the top of a hexagonal wrench to be inserted there, for example. Just like the exterior gripping profile 11 located at the other end, the interior gripping profile 16 makes the tightening of the assembly member within the flat tools easier.

In an alternative embodiment of the present invention, the head 10 is removed and the exterior gripping profile 11 is replaced with an interior gripping profile 16 that is similar or identical to the one illustrated in FIG. 3. It would also be possible to equip the two ends of the assembly member with heads 10 as previously described. It is also possible to provide a cavity in the cylindrical body 4 to lighten the assembly member 1. Furthermore the median part 6, as illustrated on FIG. 1, has a middle groove for narrowing or reducing the mass of the assembly member while preserving its sufficient mechanical properties. However, it is clear that the illustrated geometry of the median part is not required and could also be quite different. However, for an intended use, it is obviously advisable to allow a sufficient length to the median part to keep the two flat tools 2, 3 at a required useful distance apart, preferably slightly larger than the height of a stripping pin. Another alternative which is intended for a different use would also allow, in a borderline case, reducing this distance to a zero value and completely removing the median part 6.

Although the member of the present invention is preferably intended for the assembly of pairs of parallel flat tools, it would also be possible to deal with the assembly of more than two flat tools at the same time.

Regarding its manufacture, the assembly member can easily be machined from previously molded plastic. The lack of any threading and the use of helical guides 25 arranged on two pairs of wings symmetrically laid out as shown in FIG. 4, gives this member a geometry that easily enables a molding and demolding process in two elements. However, this preferred embodiment does not eliminate the possibility of having three wings per end or even a different number of them. Lastly, one will also note that the general shape of the wings, except the wing having helical guide 25, is not limited to their related function as long as it is still possible to let them pass through the openings 13 without any clearance, namely without any excessive clearance.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An assembly member for assembling first and second flat tools, each tool having a respective interior side opposed to the interior side of the other tool and each tool having a respective opposite exterior side outward of the interior side;
a respective untapped opening through each of the flat tools and through the interior and exterior sides thereof, the openings being in the same vertical plane;
a cylindrical unit having a rotation axis, including elements on the cylindrical unit and at the openings respectively cooperating and being so shaped as to enable making a solid tightened combination of the cylindrical unit and the tools by relative rotation between the cylindrical member and the tool of less than 360°.

2. The assembly member of claim 1, further comprising tightening wings at the cylindrical unit and each opposing a respective one of the exterior sides of the tool, each wing including a helical guide with a gradual incline in toward the other wing and wrapping around the wing; and the respective tool at the wing may engage the incline to be gradually tightened in the direction toward its interior side.

3. The assembly member of claim 2, wherein the cylindrical unit includes a respective abutting face which is contacted by the interior side of each of the tools as the tool is tightened by rotation of the assembly member and rotation of the wing thereof with respect to the tool.

4. The assembly member of claim 1, wherein there are wing passage openings in the tools, the opening being shaped so that the wings fit without clearance through the wing passage opening and such that upon rotation of the assembly unit, the wings are offset from the wing passage openings and no longer can pass though those openings.

5. The assembly of claim 4, wherein the cylindrical unit has opposite ends and the wings are respective toward each end of the cylindrical unit.

6. The assembly of claim 5, wherein the wings on the cylindrical unit at each tool are arranged in pairs thereof, and the openings in the tools for the wings are arranged in correspondingly shaped pairs.

7. The assembly member of claim 2, further comprising the cylindrical unit including a median part located between and spacing the wings apart axially along the cylindrical unit;
the median part including opposite spaced apart shoulders facing outwardly and the interior sides of the flat tools are supported against the shoulder upon the tightening of the cylindrical unit and the tools together.

8. The assembly member of claim 1, further comprising a gripping profile at least at one end of the cylindrical unit and shaped to facilitate revolution of the cylindrical unit around the rotation axis.

9. The assembly member of claim 8, wherein the gripping profile includes at least one of a profile defined inside the cylindrical unit and a profile defined on the outside of the cylindrical unit.

10. The assembly member of claim 8, wherein at one end of the assembly member is a head and the gripping profile being defined at the head of the assembly member.
